(19) United States
(12) Patent Application Publication
(10) Pub. No.: US 2026/0307456 A1
(43) Pub. Date: Oct. 8, 2026

(54) CONTROL SYSTEM FOR CONTROLLING A THERMAL MANAGEMENT SYSTEM OF A VEHICLE

(71) Applicant: JAGUAR LAND ROVER LIMITED, Whitley, Coventry, Warwickshire (GB)

(72) Inventors: Laurentiu-Antonin CANCEL, Whitley, Coventry, Warwickshire (GB); Thomas MOURRÉ, Whitley, Coventry, Warwickshire (GB)

(21) Appl. No.: 19/481,449

(22) PCT Filed: Apr. 30, 2024
(86) PCT No.: PCT/EP2024/061907

§ 371 Date: Nov. 4, 2025

(30) Foreign Application Priority Data
May 5, 2023 (GB) 2306673.1

(51) Int. Cl. B60H 1/00

(52) U.S. Cl. CPC B60H 1/00771; B60H 1/00392; B60H 2001/00307

(57) ABSTRACT

A control system for controlling a thermal management system of a vehicle is configured to receive route information relating to an identified route which may be undertaken by the vehicle, and determine, in dependence on the route information, a final portion of the route. Then, prior to the determined final portion of the route, a control signal is output to maintain a temperature of one or more components, fluids or volumes of the vehicle at or within a predetermined range of a desired temperature. In contrast, for the determined final portion of the route, a control signal is output to permit the temperature of the one or more components, fluids or volumes of the vehicle to deviate from the desired temperature. In this way, rather than wasting energy towards the end of a journey the components, fluids or volumes are left to cool down or warm up passively.

### TECHNICAL FIELD

The present disclosure relates to thermal management. Embodiments of the present invention relate to a system and method for controlling a thermal management system of a vehicle. Aspects of the invention relate to a system, a method of controlling a thermal management system, a computer program and a vehicle.

### BACKGROUND

The range of Battery Electric Vehicles (BEVs) is, in part, a function of the temperature of powertrain components, such as the vehicle battery and electric motors. On BEVs, a thermal management system is attempting to continuously maintain ideal powertrain temperatures using active thermal management systems. In some cases, the thermal management system serves to warm up the powertrain components from a temperature which is less than the ideal temperature, while in other cases the thermal management system serves to cool down the powertrain components from a temperature which is more than the ideal temperature. It will be appreciated that each component regulated this way might have a different ideal temperature (or temperature range).

It will be appreciated that active heating or cooling of components uses energy, and that this in turn consumes battery charge, thus reducing range. There is thus a trade-off between the additional range achieved by operating the powertrain at optimal temperatures and the range lost by using electrical energy to carry out the heating or cooling to achieve those optimal temperatures. It will therefore be appreciated that it is undesirable to actively heat or cool the powertrain components unless the benefit (in energy terms) outweighs the cost (again, in energy terms.

It is an aim of the present invention to address one or more of the disadvantages associated with the prior art.

### SUMMARY OF THE INVENTION

Aspects and embodiments of the invention provide a control system, a method of controlling vehicle thermal management, a computer program and a vehicle, as claimed in the appended claims.

In one aspect, there is provided a control system for controlling a thermal management system of a vehicle, the control system comprising one or more controller, the control system configured to:
receive route information relating to an identified route which may be undertaken by the vehicle;
determine, in dependence on the route information, a final portion of the route;
prior to the determined final portion of the route, output a control signal to maintain a temperature of one or more components, fluids or volumes of the vehicle at or within a predetermined range of a desired temperature; and
for the determined final portion of the route, output a control signal to permit the temperature of the one or more components, fluids or volumes of the vehicle to deviate from the desired temperature.

In this way, rather than wasting energy towards the end of a journey the components, fluids or volumes are left to cool down or warm up passively. That is, rather than controlling the temperature of components fluids or volumes from the start of the driving cycle until the vehicle is stopped and shut down at a destination (which for the last few miles of the driving cycle (journey) constitutes a waste of energy, since the regulated systems are going to be turned off at the destination), the thermal control of the components, fluids or volumes is regulated less (allows a higher temperature error from a setpoint for example) or is shut down completely for a final portion of the journey. Preferably this reduced regulation or shutdown is carried out only when there is a very high confidence that the vehicle is actually going to drive to and stop at the destination (for example above 95% confidence). This has the advantage of an energy saving by not using AC compressors, pumps, fans, etc. for the last few miles of the driving cycle.

It will be appreciated that the outputting of the control signal prior to the determined final portion of the route may be understood as being prior to the vehicle commencing the determined final portion of the route.

The one or more components may comprise a battery, or an inverter, or an electric machine of the electric powertrain of the vehicle. The fluid may be oil, such as a lubricating or heating/cooling oil. The one or more volumes may comprise a vehicle cabin which is heated and cooled by a heating, ventilation and air conditioning (HVAC) system. Alternatively, the volume could be another region-such as that containing batteries, luggage or other vehicle systems. It will be appreciated that different components, fluids and volumes may have different ideal temperatures or temperature ranges. The present technique may, in effect, operate in parallel but separately for each component, fluid or volume. For example, the final portion of the route may be separately determined for each—leading to active heating and cooling being discontinued or relaxed at different times for different components, fluids or volumes.

Navigation data (eHorizon) may be used to identify the last part of the journey that would not require active thermal conditioning. Once the last part of the journey has been identified, the powertrain and/or vehicle cabin may be permitted to cool/heat passively (without active regulation) which will result in less energy waste from the thermal management system over the journey.

The output signal to permit temperature deviation may deactivate the thermal management system for the one or more components, fluids or volumes. That is, the thermal management system may no longer adjust the temperature of those components, fluids or volumes. Alternatively, the output signal may cause the thermal management system to permit greater temperature variation from a temperature set point. That is, ordinarily the temperature of a given component, fluid or volume may be permitted to deviate from a particular temperature by a certain amount before heating or cooling occurs, whereas in response to the output signal a larger amount of deviation may be permitted. The larger amount of deviation may be set so that the components (for example) continue to operate safely and with adequate efficiency, or so that the vehicle volume (for example cabin) remains sufficiently comfortable for the occupants.

The present technique should only generally be used if there is a high degree of confidence of the vehicle reaching the destination (and stopping). This is because if the journey continues then the occupant comfort (HVAC) and powertrain efficiency (battery/inverter) may be affected unduly. Accordingly, the control system may be configured to determine a degree of confidence that the identified route will be completed, and configured to output the control signal to permit temperature deviation only if the determined degree of confidence satisfies a threshold. The degree of confidence does not satisfy the threshold, the temperature is not permitted to deviate in the above manner.

The degree of confidence may be dependent on a number of factors, for example being dependent on one or more of whether the driver has manually entered the route, the route having been automatically selected, and the driver having actively confirmed the route, a number of diversions from the route, and the vehicle following (and continuing to follow) the route.

In some implementations, rather than explicitly determining a degree of confidence, the outputting of the control signal may be dependent on simple criteria, such as that the driver has manually entered or confirmed the route, and that the vehicle has continued to follow the route.

The control system may be configured to maintain the temperature of the one or more components below a maximum permitted value and/or above a minimum permitted value even during the final portion of the journey. These maximum and minimum permitted values may be safety values, or may be values which if not imposed would result in an unacceptable loss of powertrain efficiency, generally offsetting the efficiency gains resulting from not actively heating or cooling the components.

The determined final portion may be from a specified distance or a specified time before the destination. While the start time (or distance in advance of the destination) may be fixed, preferably it is determined as a function of various parameters so that the temperature of the component, fluid or volume is able to remain (for example) between the maximum and minimum permitted values without active cooling. As a result, the slower the expected increase or decrease in temperature from its optimal value, the longer the final portion of the journey may be. In circumstances in which the component, fluid or volume would heat up or cool down rapidly, the final portion of the journey may be very short.

Generally, a duration or distance for the final portion of the route may be dependent on one or more environmental parameters and/or on one or more route parameters and/or on one or more operating parameters of the vehicle. The parameters which are relevant may depend on the nature of the component, fluid or volume being temperature controlled. For example, where the control system is controlling a vehicle volume, such as the cabin temperature, the output signal may be controlling a HVAC system. In this case, the one or more environmental, route and operating parameters may include an expected ambient temperature of the environment, solar load, precipitation, road gradient and traffic conditions for the final portion of the route.

In the case of electric powertrain temperature control, the operating parameters of the vehicle which may influence the duration or distance for the final portion of the route may comprise one or more of a speed of the vehicle, a current temperature within the cabin, and a number of occupants of the vehicle.

Where the one or more components comprise a battery or inverters, the operating parameters of the vehicle may comprise a power demand for a final portion of the route, which may be dependent on a gradient of each segment of the final portion, as well as an expected vehicle speed for those segments.

The thermal management system may comprise one or more of an AC compressor, a pump and a fan. Each of these is capable of performing or contributing to active heating or cooling of a vehicle component or volume.

According to another aspect of the invention, there is provided a system comprising the control system according to the above and a thermal management system.

According to another aspect of the invention, there is provided a vehicle comprising the system or the control system according to the above.

According to another aspect of the invention, there is provided a method for controlling a thermal management system of an electric vehicle, the method comprising:
receiving route information relating to an identified route which may be undertaken by the vehicle;
determining, in dependence on the route information, a final portion of the route; and
prior to the determined final portion of the route, outputting a command to the thermal management system to maintain a temperature of one or more components, fluids or volumes of the vehicle at or within a predetermined range of a desired temperature; and
for the determined final portion of the route, outputting a command to the thermal management system to permit the temperature of the one or more components, fluids or volumes of the vehicle to deviate from the desired temperature.

According to another aspect of the invention, there is provided computer readable instructions which, when executed by a computer, are arranged to perform a method according to the above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle having a battery, an electric propulsion system, a control system, and a display;

FIG. 2 schematically illustrates a control system and a group of vehicle controllers;

FIG. 3 schematically illustrates various controllers, components and volumes of the vehicle involved with thermal management;

FIGS. 4A and 4B schematically illustrate thermal control in scenarios in which the destination is unknown (FIG. 4A) and known (FIG. 4B); and

FIG. 5 is a schematic flow diagram illustrating the various steps of a thermal management method.

### DETAILED DESCRIPTION

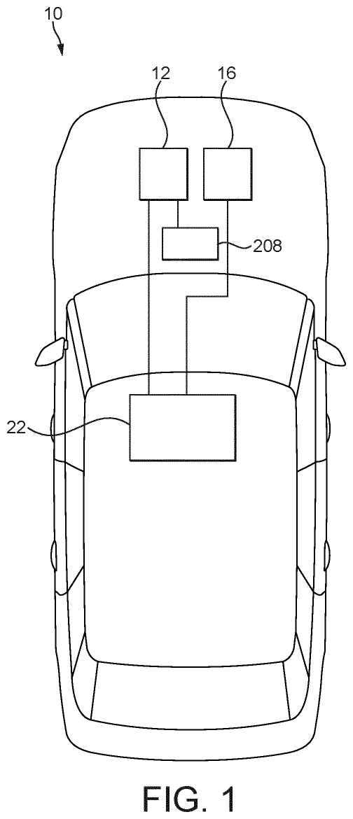

FIG. 1 illustrates an example of a vehicle 10 in which embodiments of the invention can be implemented. In some, but not necessarily all examples, the vehicle is a passenger vehicle, also referred to as a passenger car or as an automobile. In other examples, embodiments of the invention can be implemented for other applications, such as commercial vehicles. The vehicle 10 comprises a plurality of systems including an electric propulsion system 12, control system 208, and energy storage means 22 for powering the electric propulsion system 12, such as one or more batteries, for example one or more high voltage batteries. The vehicle 10 also comprises a heating, ventilation and air conditioning (HVAC) system 16 for maintaining a temperature in the vehicle cabin. The HVAC system 16 is also powered by the energy storage means 22. That is, a common energy storage means provided electrical power for both propulsion and vehicle systems, including the HVAC 16. The present technique is concerned with efficient operation of the vehicle 10, to reduce unnecessary power usage and increase vehicle range.

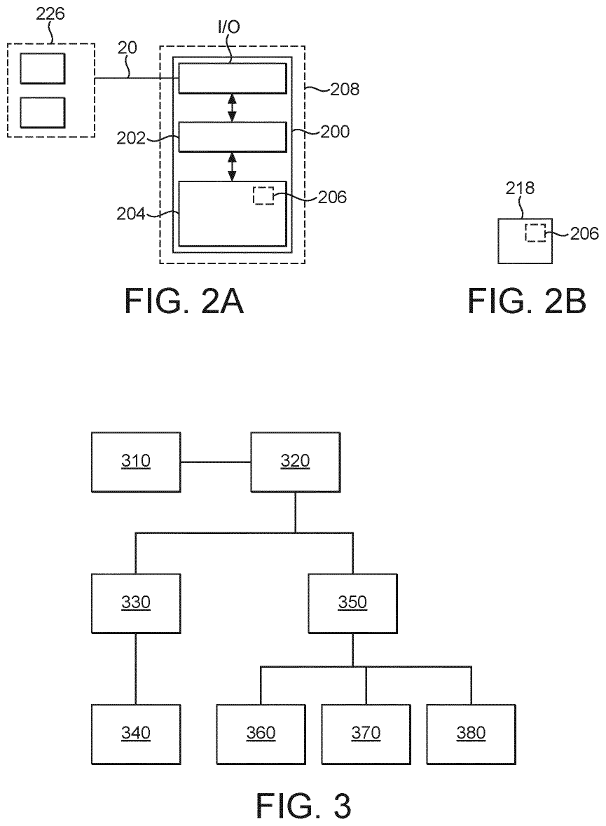

The control system 208 is configured to implement any one or more of the methods described herein. FIG. 2A illustrates how the control system 208 may be implemented. The control system 208 of FIG. 2A illustrates a controller 200. In other examples, the control system 208 may comprise a plurality of controllers 200 onboard and/or off board the vehicle 10. In examples any suitable control system 208 can be used. The controller 200 of FIG. 2A includes at least one processor 202; and at least one memory device 204 electrically coupled to the electronic processor 202 and having instructions 206 (for example a computer program) stored therein, the at least one memory device 204 and the instructions 206 configured to, with the at least one processor 202, cause any one or more of the methods described herein to be performed.

FIG. 2A therefore illustrates a control system 208, wherein the one or more electronic controllers 200 collectively comprise: at least one electronic processor 202 having an electrical input for receiving information associated with energy storage control; and at least one electronic memory device 204 electrically coupled to the at least one electronic processor 202 and having instructions 206 stored therein; and wherein the at least one electronic processor 202 is configured to access the at least one memory device 204 and execute the instructions thereon so as to cause the control system 208 to perform and/or cause performance of any one or more of the methods described herein.

Also illustrated in the example of FIG. 2A are one or more vehicle systems 226. In examples, the vehicle system(s) 226 can comprise any suitable vehicle system(s). For example, the vehicle system(s) 226 can comprise any suitable vehicle system(s) 226 from which the control system 208 can receive and/or to which the control system 208 can transmit, directly or indirectly, one or more signals 20, for example to control the energy storage means 22 of the vehicle 10. In examples, the one or more vehicle systems 226 comprise one or more systems involved in control of state of charge of the energy storage means 22 of the vehicle 10. For example, one or more vehicle systems 226 can comprise any suitable system or systems 226 of the vehicle configured to provide energy to and/or draw energy from energy storage means 22 of the vehicle 10. For example, the one or more vehicle systems 226 can comprise one or more energy recovery systems and/or one or more electric motors and so on. In examples, the one or more vehicle systems 226 can comprise one or more systems configured to report on the present state and/or present usage of energy by the energy storage means 22 of the vehicle 10. In examples, the one or more vehicle systems 226 can comprise one or more systems configured to provide information to allow a determination of a predicted destination 12 for the vehicle 10 and/or an associated confidence value. In examples, the one or more systems 226 comprise a powertrain controller module and/or an infotainment system and/or a HVAC controller.

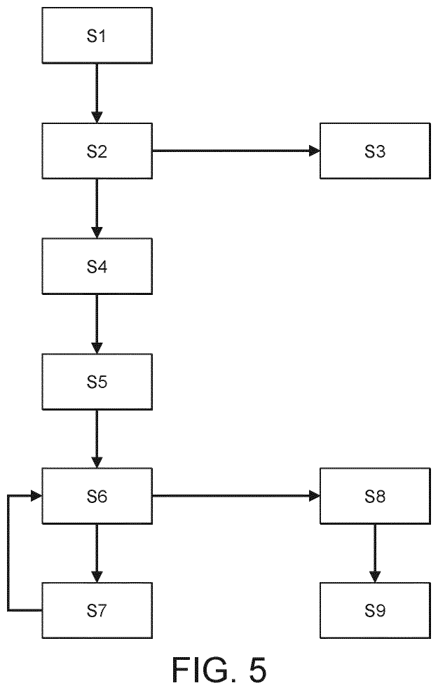

FIG. 2B illustrates a non-transitory computer readable storage medium 218 comprising the instructions 206 (computer software). Accordingly, FIG. 2B illustrates a non-transitory computer readable medium 218 comprising computer readable instructions 206 that, when executed by a processor 202, cause performance of at least the method of one or more of FIG. 5 and/or as described herein.

The present invention principally considers two scenarios. The first scenario is that of electric powertrain efficiency. In particular, certain components of the electric powertrain, such as batteries, inverters and electric motors, operate most effectively or efficiently at a specified temperature, or within a specified temperature range. If the temperature deviates from these, efficiency may drop. In addition to physical components, the oil (fluid) used to lubricate the transmission and e-motor can be also cooled/heated. It will be appreciated that the oil may in this case be considered as a vehicle component. Increasing the temperature of the oil results in lower friction forces hence higher efficiency. This then leads to an improvement in vehicle range.

As a result of the temperature dependence of powertrain efficiency, it is known to passively and actively heat or cool vehicle components to specified temperatures. Where active heating or cooling is used, this consumes electrical power, and therefore itself negatively impacts on efficiency. It will be generally appreciated that it is only worth heating or cooling powertrain components if the energy efficiency savings made outweigh the energy cost of heating or cooling. The present technique recognises that for a final portion of the journey before the vehicle comes to a halt, the active heating or cooling is less beneficial. This is because the normal trade-off between the energy cost of actively maintaining the temperature of vehicle components and the efficiency gain with those components assumes continuing (future) use of those components, whereas in the final portion of a journey there will not be (future) continuing use of the components (or less continuing use). Instead, the powertrain components may be permitted to deviate from their optimal temperatures during this final portion, resulting in a net reduction in electrical power consumption and an increase in vehicle range (and/or battery fill level at the conclusion of the journey). Accordingly, the control methodology proposed either switches off the active heating or cooling of those components for this final portion of the journey, or changes the temperature setpoint for those components so that less heating or cooling is required (thereby using less electrical power).

The second scenario is that of vehicle cabin temperature regulation. In this case, active heating or cooling of a vehicle cabin to a desired temperature using an HVAC system consumes electrical power. This is required for occupant comfort, but does reduce vehicle range. The present technique recognises that for a final portion of the journey before the vehicle comes to a halt, and depending on certain factors, the temperature in the vehicle cabin may deviate from a desired value sufficiently slowly as to not be uncomfortable for the occupants. Accordingly, the control methodology proposed either switches off the HVAC system for this final portion of the journey, or changes the temperature setpoint so that the HVAC system works less hard (uses less electrical power). In addition to the vehicle cabin, other volumes (spaces) within the vehicle may be similarly regulated in this way (not necessarily by the HVAC system), such as a space containing batteries, luggage or other vehicle systems.

In both cases, route information relating to an identified route which may be undertaken by the vehicle is received (or determined) by a controller. In dependence on the route information, a final portion of the route is determined. For example, a distance along (or before the end of) the route, or a time prior to the destination being (expected to be) reached, is determined as the start of the final portion. The methodology for determining the size (length or duration) of the final portion will be explained in detail below. Once the final portion of the journey has been determined, thermal control of one or more components or volumes of the vehicle is carried out differently, depending on whether the vehicle is in or prior to the final portion. In particular, prior to the determined final portion of the route, a control signal is output (to a thermal control system) to maintain a temperature of one or more components, fluids or volumes of the vehicle at or within a predetermined range of a desired temperature, whereas for the determined final portion of the route, a (different) control signal is output to permit the temperature of the one or more components of the vehicle to deviate from the desired temperature (or temperature range).

Broadly, the temperature may be permitted to deviate in two ways. In one case, the output signal to permit temperature deviation may deactivate the thermal management system for the one or more components or volumes. That is, no active heating or cooling will be applied (potentially subject to a safety or comfort threshold). That is, the thermal management system may no longer adjust the temperature of those components or volumes (except optionally via passive means). Alternatively, the output signal may cause the thermal management system to permit greater temperature variation from a temperature set point. That is, ordinarily the temperature of a given component or volume may be permitted to deviate from a particular (target) temperature by a certain amount before active heating or cooling occurs, whereas in response to the output signal a larger amount of deviation may be permitted. The larger amount of deviation may be set so that the components (for example) continue to operate safely and with adequate efficiency, or so that the vehicle volume (for example cabin) remains sufficiently comfortable for the occupants. In other words, even during the final portion of the journey, the control system may be configured to maintain the temperature of the one or more components below a maximum permitted value and/or above a minimum permitted value. These may be safety values, or may be values which if not imposed would result in an unacceptable loss of powertrain efficiency, generally offsetting the efficiency gains resulting from not actively heating or cooling the components.

In FIG. 3, several of the vehicle systems 226 are shown, including a user Plug-In-Vehicle Infotainment system (PIVI) 310, a controller 320, a HVAC system 330 and a powertrain control module 350. The PIVI 310 carries out navigation functionality, and outputs eHorizon data to the controller 320. The PIVI 310 also comprises a user interface via which the user may input commands. The eHorizon data comprises route information concerning a journey planned to be undertaken by the vehicle. The HVAC system 330 heats and cools a vehicle cabin 340 of the vehicle, in part dependent on control signals from the controller 320. The powertrain control module 350 carries out various control functions in relation to the vehicle electric powertrain (as is conventional), and in the present technique controls the temperature of a vehicle battery 360, electric motors 370 and inverters 380. In particular, the powertrain control module 350 passively and/or actively heats and/or cools the battery 360, motors 370 and inverters 380 in order that the powertrain is operated as efficiently as possible. While not shown in FIG. 3, a lubricating fluid (oil) may also be heated or cooled actively via the powertrain control module 350. Various heating and/or cooling systems may be used to heat or cool the various components, including an AC compressor for the vehicle cabin, and a pump and a fan to cool the battery, motors and inverters.

The eHorizon data output by the PIVI 310 comprises, for each of the segments of the planned journey, a segment offset (Oseg), a segment gradient (Sseg), and a segment speed (Vseg). The segment offset is in effect a length/distance of the segment (since subtracting the offset of a preceding segment from a particular segment will provide the length of the particular segment), the segment gradient is a road gradient for the segment. This may be an average gradient for the portion of the road corresponding to that segment. Since segments need not be all of the same length, generally new segments will be defined whenever the road gradient changes significantly, with the result that the gradient is at least generally uniform for the portion of road corresponding to any given segment. The segment speed is an assumed average speed for the segment, based on historical traffic data from multiple users. It will be appreciated that different users may traverse the segment at different speeds, and the segment speed is an average of these. The gradient and expected vehicle speed for any given gradient may be used to estimate an expected power load on the vehicle during that segment. For example, the greater the positive gradient, the greater the expected power load, and the greater the speed, the greater the expected power load.

With the present invention, the expected power load is useful for determining the length or duration of the final portion of the journey, during which active heating or cooling of the powertrain components is to be relaxed. In particular, when switching off (or relaxing) thermal management as approaching a final destination, the time t[s] before the destination when the thermal system control can be switched off for the following components (cabin, high voltage battery, electric drive unit (EDU), oil) may be calculated as:

$$t = \frac{m \cdot {C}_{p} \cdot Δ T}{{P}_{l o s s}}$$

Where P [W]=power losses, m [kg]=thermal mass of component, ΔT [K]=T_{final}−Tᵢₙᵢₜᵢₐₗ (temperature difference) and Cₚ[J/kg·K]=specific heat coefficient of component.

For each component being actively heated or cooled in accordance with the present technique, there will be a time calculated, resulting in separate time values. In other words, the time in advance of the destination at which thermal control will be discontinued (or relaxed) may be different for each component, fluid or vehicle volume.

For the cabin the power losses may be mapped as a static table function of cabin temperature setpoint and external temperature. That is, the greater the difference between the cabin temperature setpoint and external temperature, the greater the power losses.

For the battery and EDU, the power losses may be calculated function of eHorizon data and vehicle road load equation. This will be described in more detail below.

The specific heat coefficient will be specific for the battery pack and EDU.

The temperature delta will be calculated function of the current temperature of the component and the targeted temperature at the destination. The targeted temperature at the destination may be a maximum or minimum permissible temperature for the component, or a maximum permissible deviation from the temperature setpoint of the component.

More generally, a duration or distance for the final portion of the route may be dependent on one or more environmental parameters and/or on one or more route parameters and/or on one or more operating parameters of the vehicle. In the case of powertrain components for example, the environmental factors may include the ambient temperature, the route parameters may be the gradient and likely speed (and if available, traffic information) in the final sequence of segments of the route, and the vehicle operating parameters may be a terrain mode of the vehicle, and an indication of a power load of vehicle systems such as lights, HVAC etc. In the case of a volume such as the vehicle cabin, the one or more environmental, route and operating parameters may include an expected ambient temperature of the environment, solar load, precipitation, road gradient and traffic conditions for the final portion of the route. For example, a high ambient temperature and high solar load may result in the vehicle cabin heating up rapidly. This would mean that the duration of the final portion of the journey would need to be short.

The operating parameters of the vehicle which may influence the duration or distance for the final portion of the route may comprise one or more of a speed of the vehicle, a current temperature within the cabin, and a number of occupants of the vehicle.

Where the one or more components comprise a battery or inverters, the operating parameters of the vehicle may comprise a power demand for a final portion of the route.

A journey may be considered to be a route between a starting location and a destination, optionally via one or more waypoints. In one example, the route is published by the vehicle navigation system (part of the PIVI 310). In this example, the starting location, destination and waypoints may be deterministic because they are specified by user inputs to the vehicle navigation system. Therefore, in this example, the route is deterministic. In another example, the route is predicted from machine learning. The machine learning could indicate where the vehicle 10 has previously been driven and at which times. This enables the route to be determined probabilistically. For example, at 8 am on a weekday the driver normally drives to work, which trains a predictive algorithm to determine that when the driver enters their vehicle 10 at 8 am on a weekday, they are going to follow a particular route.

With the present technique, it is not desirable to discontinue heating or cooling if the vehicle is in fact not going to stop at an expected destination. Accordingly, it is desirable that the present technique should be applied only if a degree of confidence in the planned route is sufficient (greater than a threshold value). In practice, the degree of confidence of the vehicle reaching the destination (and stopping) should be high in order that the heating/cooling be discontinued for the final portion. This is because if the journey continues then the occupant comfort (HVAC) and powertrain efficiency (battery/inverter) may be effected unduly.

In some implementations, the degree of confidence in a planned route may be determined by a combination of four factors. These factors a type of destination—which may be one of a destination set by the driver in the navigation system, a destination identified as a commute route and acknowledge by driver, a destination identified as commute route but not acknowledged by driver, and no destination selected or identified. In the case of a destination set by or acknowledged by the driver, the confidence requirement may be considered to have been met and the control algorithm to discontinue or relax heating/cooling actioned. In the case of an identified but unacknowledged commute route, additional consideration is required. This consideration may be made in dependence on a base confidence in the commute route as a percentage value, for example an 89% confidence level, a number of reroutes from the commute route, and a (remaining) distance to the destination in km. For example, in this case the heating/cooling relaxation or discontinuation during the final portion of the journey may be carried out only if the confidence in the commute route is greater than a threshold value (for example 80%), if the vehicle has been driven on the route for at least a predetermined proportion (for example 10%) of the identified commute without re-routing (driver deviation and another route identified), this check being done using the distance to destination signal in km, and if there have been no more than a specified maximum number (for example 3) of re-routes from the initial identified commute route. If any of these conditions are not met, thermal management is not discontinued or relaxed for the final portion of the journey.

Once the route is known, and satisfies the confidence requirements, the power use of the vehicle 10 is predicted for the journey following that route. The present technique uses vehicle speed, but may additionally use other useful variables including a distance-dependent parameter such as distance, and a gradient-dependent parameter such as road gradient or elevation points from which gradient can be determined. Other useful parameters include vehicle mass, aerodynamic drag coefficient(s), road curvature (e.g. curve radius-dependent or a number of bends), road type (e.g. road classification, number of lanes). The controller 320 may be configured to perform a force analysis of the available parameters to predict the power to be used for the vehicle journey, in accordance with Newton's second laws of motion. In some examples, a model of the drivetrain and/or powertrain of the vehicle 10, and auxiliary electrical loads (e.g. lighting, heating, cooling, engine accessories) can be used to account for losses therefrom.

The journey may be represented as a plurality of segments. The speed, gradient and other information is quantized by the controller 320 to a constant value over each segment. The number of segments into which the journey is divided corresponds to a degree of spatial and/or temporal resolution. The width of each segment may correspond to a particular time and/or distance (width on the x-axis), and may be different from the width of at least one other segment. In an example, each segment represents a line between two nodes on a graph representative of a road network. The graph may be that used by a route-finding algorithm such as Dijkstra's algorithm implemented in the vehicle navigation system, for finding the route. The node-to-node spacing is variable because each node may correspond to one of a real road junction or to a helper node for improving spatial resolution (e.g. accounting for road curves). Therefore the segment widths are variable. The segmentation may occur in the vehicle navigation system for the purposes of route calculation, prior to receipt of the information, or in other examples the controller 320 may perform the segmentation.

The information provided to the powertrain control module, to estimate the energy usage of the various segments of the journey, may be considered to be a driving profile for the journey. The driving profile therefore comprises an expected vehicle speed for each of a plurality of segments of the journey (each segment having a particular gradient, and a length). Using the driving profile, and in particular these three parameters, along with a set of constants C1, C2, C3, it is possible to estimate an amount of power which will be consumed during traversal of each segment, according to the following Equation (2):

$${P}_{s e gment} ( W ) = ( {C}_{1} + {C}_{2} \cdot {V}_{s e gment} + {C}_{3} \cdot {V}_{s e gment}^{2} + m \cdot g \cdot \frac{{S}_{s e g ment} [ \% ]}{100} ) \qquad ( 2 )$$

In equation (2), P_{segment} [W] is the amount of power (in Watts) consumed by traversal of the segment (output), V_{segment} is the segment speed, m is the mass of the vehicle (kg), g is the gravitational constant, S_{segment} is the gradient of the segment.

With the present technique, the power load for the last segments of the journey can be used as an input to Equation (1) above in determining the time before the destination at which active heating/cooling should be ceased.

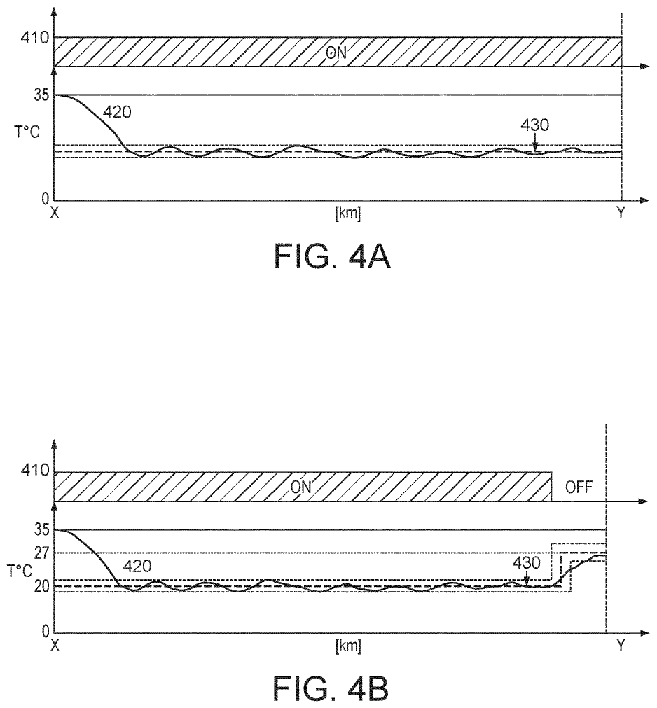

FIGS. 4A and 4B show how the thermal control of a vehicle cabin using an HVAC system may be handled for unknown and known journeys.

Referring to FIG. 4A, thermal management control in a case where the journey is not known in advance is shown. For the purpose of this example, an outside temperature of 35 C is used, and the HVAC system is on for the whole duration of the journey to maintain cabin temperature (status 410=ON for the entirety of the journey). As can be seen from FIG. 4A, at the start of the journey X the cabin temperature 420 is the same as the ambient temperature, but as the HVAC system begins to operate the cabin temperature 420 reduces to a desired temperature (cabin temperature setpoint 430). It then fluctuates around this setpoint, within limits, until the journey is complete at Y. Since the end point of the journey is not known by the control system in FIG. 4A, it is not possible to apply the present technique.

Referring to FIG. 4B, thermal management control in a case where the journey is known in advance is shown. For the purpose of this example, the outside temperature is again 35 C. In this case, the HVAC system is on (status 410 is ON) for the majority of the journey to control the cabin temperature, but is turned off in advance of the destination to save energy (usually consumed by an AC compressor, blowers, fans, etc). In other words, the control for FIG. 4B is the same as that of FIG. 4A up until a specified time period (or distance) in advance of the destination, at which point the control of FIG. 4B differs by switching off the HVAC heating/cooling. It can be seen from FIG. 4B that the cabin temperature 420 is the same as for FIG. 4A until the HVAC is switched off, at which point it begins to rise. However, the selection of the timing for the HVAC to be switched off is such that the temperature will not rise to an unacceptable level within the time left of the journey.

While FIGS. 4A and 4B relate to HVAC control, exactly the same principles may be applied to active thermal control of components of the electric powertrain, that is, to the battery, motors and inverters.

Referring to FIG. 5, a flow diagram for the method is provided. At a step S1, route information is received from the PIVI. This route information will be in relation to a journey to a destination. At a step S2, it is determined whether a degree of confidence in the destination can be satisfied. If not, the process ends at a step S3. If the step S2 is satisfied, then at a step S4 the power load of the component or volume being temperature controlled is determined. Then, at a step S5, the power load and other parameters are used to determine a time (or distance) in advance of the destination at which active heating/cooling of the component or volume should cease. At a step S6 it is determined whether the final portion of the journey (for which the temperature is not to be actively controlled) has been reached. If not, active control continues at a step S7, and the process returns to the step S6. If the final portion of the journey is determined at the step S6 to have been reached, the active heating/cooling is discontinued at a step S8. This continues until the destination is reached at a step S9.

Preferably, during the step S8, the temperature of the component or volume is still monitored, and the thermal management turned back on, or controlled to heat or cool as required, if the temperature exceeds an upper (safety, comfort or inefficiency) threshold, or drops below a lower (safety, comfort or inefficiency) threshold. In a sense, in this embodiment temperature regulation is still carried out during the final portion of the journey, but much greater deviation/variation of the temperature (from an optimal or desired temperature or setpoint) is permitted during the final portion of the journey.

As used herein “for” should be considered to also include “configured or arranged to”. For example, “a control system for” should be considered to also include “a control system configured or arranged to”.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

For purposes of this disclosure, it is to be understood that the controller(s) described herein can each comprise a control unit or computational device having one or more electronic processors. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application. The blocks illustrated in the FIG. 5 may represent steps in a method and/or sections of code in the computer program 206. The illustration of a particular order to the blocks does not necessarily imply that there is a required or preferred order for the blocks and the order and arrangement of the block may be varied. Furthermore, it may be possible for some steps to be omitted.

As used herein, the term “determining” (and grammatical variants thereof) can include, not least; calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also “determining” can include resolving, selecting, choosing, establishing, and the like.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A control system for controlling a thermal management system of a vehicle, the control system comprising one or more controller, the control system configured to:
receive route information relating to an identified route which may be undertaken by the vehicle;
determine, in dependence on the route information, a final portion of the route;
prior to the determined final portion of the route, output a control signal to maintain a temperature of one or more components, fluids or volumes of the vehicle at or within a predetermined range of a desired temperature; and
for the determined final portion of the route, output a control signal to permit the temperature of the one or more components, fluids or volumes of the vehicle to deviate from the desired temperature or predetermined range.

2. The control system of claim 1, wherein the output signal to permit temperature deviation deactivates the thermal management system for the one or more components, fluids or volumes.

3. The control system of claim 1, wherein the output signal to permit temperature deviation causes the thermal management system to permit greater temperature variation from a temperature set point.

4. The control system of claim 1, wherein the one or more components, fluids or volumes comprise one or more of a heating, ventilation and air conditioning system, oil, a battery, and an electric machine.

5. The control system of claim 1, wherein the control system is further configured to determine a degree of confidence that the identified route will be completed, and configured to output the control signal to permit temperature deviation if the determined degree of confidence satisfies a threshold.

6. The control system of claim 5, wherein the degree of confidence is dependent on one or more of whether the driver has manually entered the route, the route having been automatically selected, and the driver having actively confirmed the route, and the vehicle following the route.

7. The control system according to claim 1, wherein the control system is further configured to maintain the temperature of the one or more components, fluids or volumes below a maximum permitted value and/or above a minimum permitted value.

8. The control system according to claim 1, wherein the determined final portion is from a specified distance or a specified time before the destination.

9. The control system according to claim 1, wherein a duration or distance for the final portion of the route is dependent on one or more environmental parameters and/or on one or more route parameters and/or on one or more operating parameters of the vehicle.

10. The control system according to claim 9, wherein the one or more components comprise a heating, ventilation and air conditioning system, and the parameters comprise one or more of an expected ambient temperature of the environment, solar load, precipitation, road gradient and traffic conditions for the final portion of the route.

11. The control system according to claim 10, wherein the operating parameters of the vehicle comprise one or more of a speed of the vehicle, a current temperature within the cabin, and a number of occupants of the vehicle.

12. The control system according to claim 9, wherein the one or more components comprise a battery or inverters, and the operating parameters of the vehicle comprise a power demand for a final portion of the route.

13. The control system according to claim 1, wherein the thermal management system comprises one or more of an AC compressor, a pump and a fan.

14. A system comprising the control system of claim 1 and the thermal management system.

15. A vehicle comprising the system of claim 14.

16. A method for controlling a thermal management system of an electric vehicle, the method comprising:
receiving route information relating to an identified route which may be undertaken by the vehicle;
determining, in dependence on the route information, a final portion of the route; and
prior to the determined final portion of the route, outputting a command to the thermal management system to maintain a temperature of one or more components, fluids or volumes of the vehicle at or within a predetermined range of a desired temperature; and
for the determined final portion of the route, outputting a command to the thermal management system to permit the temperature of the one or more components, fluids or volumes of the vehicle to deviate from the desired temperature.

17. Computer readable instructions which, when executed by a computer, are arranged to perform the method according to claim 16.

18. A vehicle comprising the control system of claim 1.
